(19) United States
(12) Patent Application Publication
(10) Pub. No.: US 2018/0109408 A1
(43) Pub. Date: Apr. 19, 2018

(54) Hybrid PAPR Reduction for OFDM

(71) Applicant: Kabushiki Kaisha Toshiba, Tokyo (JP)

(72) Inventors: Magnus Stig Torsten SANDELL, Bristol (GB); Filippo TOSATO, Bristol (GB)

(73) Assignee: Kabushiki Kaisha Toshiba, Tokyo (JP)

(21) Appl. No.: 15/504,333

(22) PCT Filed: Jun. 25, 2015
(86) PCT No.: PCT/GB2015/051850

§ 371 Date: Feb. 16, 2017

(51) Int. Cl. H04L 27/26

(52) U.S. Cl. CPC H04L 27/2615

(57) ABSTRACT

A device comprising an input for receiving an OFDM signal, a processor and a memory for storing code. The code is configured to, when executed by the processor, cause the processor to generate a modified signal with reduced PAPR based on the OFDM signal by performing first and second PAPR reduction methods. In the first PAPR reduction method an intermediate signal is generated so that the number of signal peaks above a predetermined threshold is substantially minimised. In the second PAPR reduction method the PAPR of the intermediate signal is reduced.

### FIELD

Embodiments described herein relate generally to PAPR reduction and to the reduction of PAPR of an OFDM signal in a computationally inexpensive manner.

### BACKGROUND

OFDM is an efficient way of transmitting high data-rate signals due to its capability of splitting the wideband signal into many narrowband sub-signals, thus simplifying equalisation at the receiver. However its main drawback is the large peak-to-average-power ratio (PAPR) which is caused by the summation of many sub-signals. In systems with a large number of subcarriers, such as TV broadcasting and ADSL, this can cause significant problems with the power amplifier (PA) and lead to severe power losses. This necessitates the use of PAPR reduction techniques at the transmitter. PAPR reduction has been studied for a long time and a number of solutions have been proposed. These use different techniques, such as encoding, phase rotations or adding signals that will reduce the peaks of the signal. Often the techniques have a number of parameters which can trade off performance for complexity and/or overhead. The main problem with PAPR reduction is that it is very computationally intensive to achieve good performance.

### BRIEF DESCRIPTION OF THE DRAWINGS

In the following, embodiments will be described with reference to the drawings in which:

FIG. 1 is illustrates the separation of subcarriers into non-overlapping groups in partial transmit sequences (PTS) PAPR reduction method;

FIG. 2 shows tone allocation in the tone reservation (TR) PAPR reduction method;

FIG. 3 shows a hybrid PAPR reduction method according to an embodiment;

FIG. 4 shows the modified PTS method according to an embodiment;

FIG. 5 shows the result of a simulation of PAPR reduction achieved after the second/TR PAPR reduction of the embodiment as a function of the number of significant peaks of the input to the second/TR PAPR reduction step;

FIG. 6 illustrates the principle of TR-AS;

FIG. 7 shows a receiver configured to implement a hybrid PAPR reduction scheme of embodiments; and

FIG. 8 shows simulation results of the performance of the hybrid PAPR reduction scheme of an embodiment.

### DETAILED DESCRIPTION

In an embodiment a method of reducing PAPR of an OFDM signal comprises a first PAPR reduction method in which an intermediate signal is generated so that the number of signal peaks above a first predetermined threshold is substantially minimised and a second PAPR reduction method in which the PAPR of the intermediate signal is reduced.

In an embodiment the first PAPR reduction method is a partial transmit sequence (PTS) method in which a codeword that reduces or subtantialy minimises the peaks above the first predetermined threshold is chosen.

In an embodiment the codeword is the DFT matrix.

In an embodiment the second PAPR reduction method is a tone reservation (TR) method.

In an embodiment, in the second PAPR reduction method, a tone reserved signal is optimised only with respect to signal peaks that have an amplitude above a second predetermined threshold.

In an embodiment the TR method an average power of the TR signal is limited.

In an embodiment a method of reducing PAPR of an OFDM signal comprises initially reducing PAPR using PTS in a low or medium complexity, medium or high PAPR reduction region and, thereafter, reducing PAPR further using TR in a low or medium complexity medium or high PAPR reduction region.

In an embodiment a method of reducing PAPR of an OFDM signal using tone reservation by optimising a tone reservation signal based only on peaks of the OFDM signal that are above a predetermined threshold.

In an embodiment a device comprises an input for receiving an OFDM signal, a processor and a memory for storing code. The code is configured to, when executed by the processor, cause the processor to generate a modified signal with reduced PAPR based on the OFDM signal by performing a first PAPR reduction method in which an intermediate signal is generated so that the number of signal peaks above a predetermined threshold is substantially minimised and a second PAPR reduction method in which the PAPR of the intermediate signal is reduced.

In an embodiment the first PAPR reduction method is a partial tranmit sequence (PTS) method in which a codeword that reduces or subtantialy minimises the peaks above the first predetermined threshold is chosen.

In an embodiment the codeword is the DFT matrix.

In an embodiment the second PAPR reduction method is a tone reservation (TR) method.

In an embodiment the TR method a tone reserved signal is optimised only with respect to signal peaks that have an amplitude above a predetermined threshold.

In an embodiment the TR method an average power of the TR signal is limited.

In an embodiment a device comprises an input for receiving an OFDM signal, a processor and a memory for storing code. The code configured to, when executed by the processor, cause the processor to generate a modified signal with reduced PAPR based on the OFDM signal by initially reducing PAPR using PTS in a low or medium complexity, medium or high PAPR reduction region and, thereafter, reducing PAPR further using TR in a low or medium complexity medium or high PAPR reduction region.

In an embodiment a device comprises an input for receiving an OFDM signal, a processor and a memory for storing code, the code configured to, when executed by the processor, cause the processor to generate a modified signal with reduced PAPR based on the OFDM signal by selecting peaks of the OFDM signal that are above a predetermined threshold and reducing PAPR of an OFDM signal only on the selected peaks.

In an embodiment an OFDM transmitter comprises an aforementioned device and a transmitting unit configured to receive a PAPR reduced OFDM signal and transmit it into a wireless transmission channel.

In an embodiment the OFDM transmitter is a base station or a TV broadcaster.

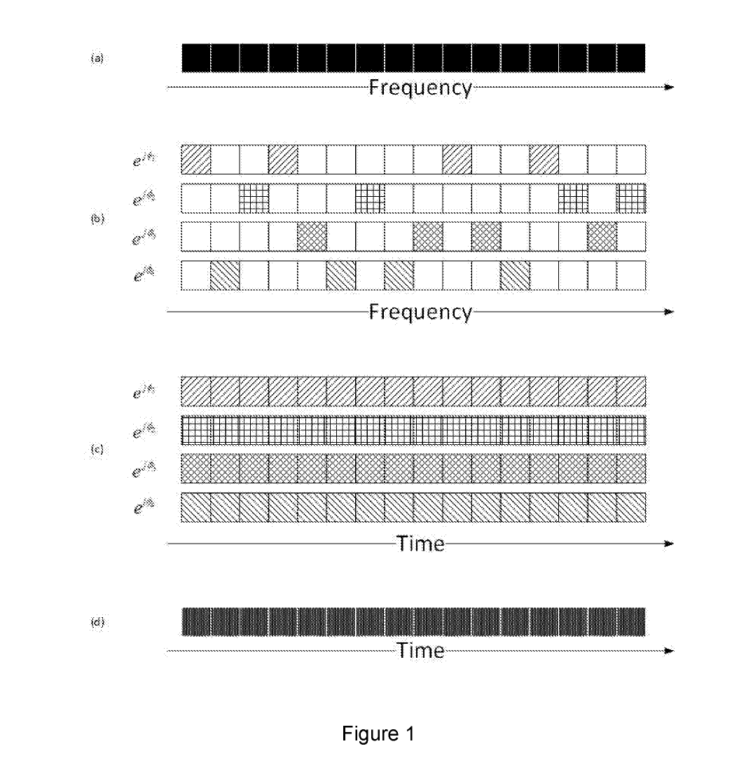

One known technique for PAPR reduction is the partial transmit sequences (PTS) technique by Müller et al (Müller, S., & Huber, J. (1997, February), OFDM with reduced peak-to-average power ration by optimum combination of partial Transmit sequences, IEE Electronics Letters, 33(5), 368-369). PTS requires low computational complexity. The operating principle of PTS is shown in FIG. 1. The subcarriers of the signal to be transmitted are split into a number of non-overlapping groups (FIG. 1b) and the IDFT is computed for each partial signal (FIG. 1c). Some unit magnitude weights e^{jϕ}^{ᵢ} are then computed such that when the partial time-domain signals are combined using these weights, the PAPR is as low as possible. The combined signal is then transmitted along with the information of which weights were used. Typically these weights are chosen from a codebook and only the index to the used codeword is required to be conveyed to the receiver (which also has the codebook from which the codeword was chosen). At the receiver, an FFT is computed and the frequency-domain signal is derotated using the weights e^{jϕ}^{ᵢ}. The main drawback with this method is that a large codebook is required to achieve good performance, which increases both the complexity and overhead.

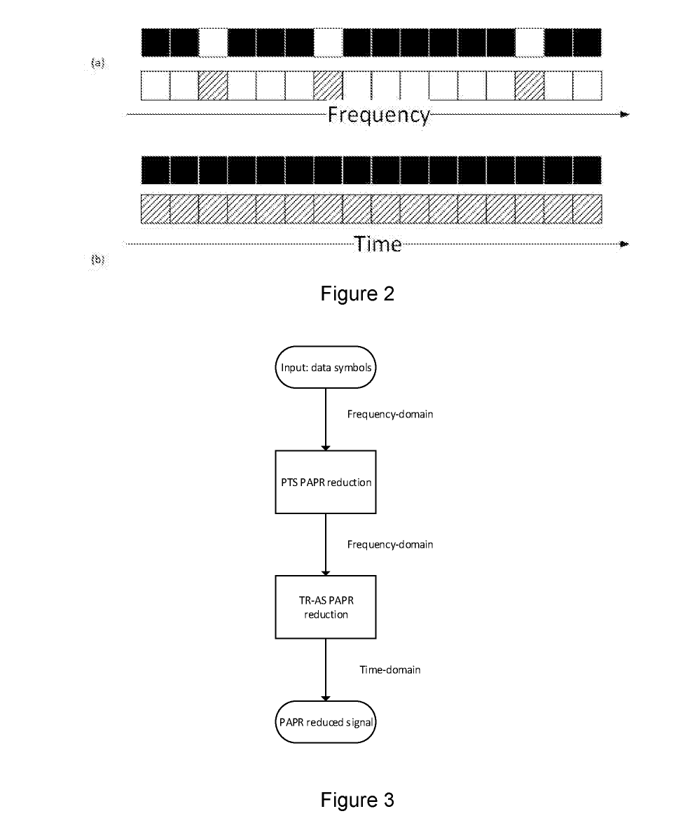

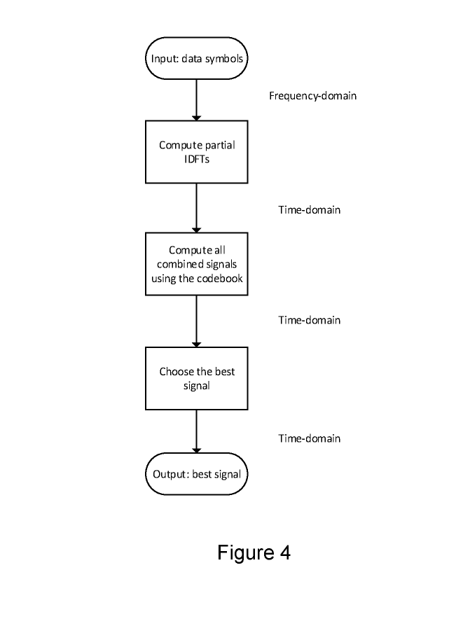

Another approach, known as tone reservation (TR) (as mentioned in Rahmatallah, Y., & Mohan, S. (2013, Fourth Quarter). Peak-To-Average Power Ratio Reduction in OFDM Systems: A Survey And Taxonomy. IEEE Communications Surveys & Tutorials, 4(15), 1567-1593), is to assign a number of tones in the OFDM signals for the use of PAPR reduction and hence not transmit data on them. This is illustrated in FIG. 2. The non-data carrying tones can be constructed such that when combined with the time-domain data signal, it produces a signal with low PAPR. This combined signal is then transmitted and at the receiver, the symbols on the TR tones are simply ignored since they contain no information about the data signal. The main drawback with this method is the high complexity of finding what values to Transmit on the TR tones to minimise the PAPR.

A modification to the tone reservation technique is tone reservation using active sets, referred to as TR-AS in this disclosure, by Krongold et. al. (Krongold, B., & Jones, D. (2004, February). An Active-Set Approach for OFDM PAR Reduction via Tone Reservation. IEEE transactions on Signal Processing, 52(2), 495-509). This technique offers good performance but requires many processing steps. This can make use of the technique impractical. TR-AS was shown to converge in a finite number of steps if there are no constraints on the power of the TR-AS signal. In practice the power of the TR-AS signal must be limited as it is a power loss from a data transmission point of view, given that the TR-AS signal is ignored at the receiver and not used for data detection.

On the other hand, PTS is a simple method but does not deliver as good performance as TR-AS. The inventors have realised that what is common to both methods is that they offer diminishing returns for increased complexity. The largest improvements in performance are when the complexity goes from low to medium but beyond that the improvements are only gradual. Embodiments combine these two methods, wherein each operating in its “low complexity region”. Thereby the performance-complexity trade-off is improved.

With both the PTS and TR-AS method, as well as most or even all known PAPR reduction methods, the most improvement in performance is obtained for the low-complexity region. In PTS, the PAPR improvement decreases as the size of the codebook (and hence the complexity) is increased. In TR-AS, the PAPR improvement decreases after the first few iterations. The inventors have realised that this is because, as the number of peak that need to be considered when a new descent direction vector is generated during an iteration, computational complexity increases alongside it.

The inventors have invented a way of combining two PAPR reduction methods in a manner that allows using the computationally less onerous, yet in terms of PAPR reduction performance more efficient early operating stages of the respective methods. This is achieved by providing an interface between the two methods that ensures that the second method only needs to operate on a signal for which the number of peaks above a predetermined threshold has already been substantially minimised. As the second one of the two PAPR reduction methods is available to provide PAPR reduction beyond that achieved by the first method the first one of the two methods does not have to be operated in the computationally more demanding yet in terms of PAPR reduction performance less valuable operating regions. Because the number of peaks above the predetermined threshold that the second method has to operate upon has already been reduced the operation of the second method is moreover more efficient, so that satisfactory PAPR reduction can be obtained within the initial and computationally less complex operating stages of the second method.

The embodiments described in the following provide an illustration that uses PTS and TR or TR-AS as example PAPR reduction methods. However, the embodiments are not limited to the use of these example methods, nor to their combination with each other. In the embodiments described in the following PTS is first applied to a signal to be transmitted, using only a small codebook. Thereafter TR or TR-AS is applied with a small number of iterations. The use of the small codebook reduces the complexity of PTS. Ensuring that TR or TR-AS requires only a small number of iterations reduces the complexity of this second method.

PTS:

In one embodiment the low complexity operation of PTS is exploited by dividing the signal to be transmitted into a small number of subblocks, V, in the frequency domain. A sub-block is the set of indices of the tones included in a sub-set as shown, for example in FIG. 1b. An orthogonal codebook, V×V is moreover used. The orthogonality criterion means that two set sets of phase rotations, e^{jϕ}^{ᵢ} and e^{jϕ}^{ₖ}, have the property

$${\sum }_{v = 0}^{V - 1} {e}^{j {ϕ}_{i , v} {e}^{- j {ϕ}_{k , v}}} = \{ \begin{matrix}V & i = k \\ 0 & i \neq k\end{matrix}$$

If two codewords are orthogonal to each other, the combined signals using these codewords are unlikely to have the same PAPR. Hence by choosing the best out the available combined signals, the chances are maximised to find a signal with low PAPR. It was further realised that, if further codewords were added to the codebook, they can't all be orthogonal and that, consequently, the performance improvements available from increasing the size of the codebook are limited.

Since the PTS method is only the first stage of the PAPR reduction method of the embodiment, there is no need to optimise its PAPR. Instead the combined signals are chosen so that they act as the best input signal to the second stage.

TR-AS:

In each step of known TR methods, the data signal and a time domain signal (hereinafter referred to as TR signal or as descent direction vector respectively) generated from the reserved tones discussed above with reference to FIG. 2 are added. The TR signal is phase shifted, so that, in the time domain, its main peak at least partially cancels the data peak with the largest amplitude. As this cancellation in one part of the time domain data signal almost inevitably brings about an increase in peak amplitude in another part of the time domain data signal the same consideration has to be repeated for the thus altered signal. In a second iteration two of the TR signals are individually phase shifted so that, in the time domain, they individually affect (so as to reduce or cancel) one of the signal peaks of the data signal in the time domain, so that PAPR is reduced by virtue of lowering the amplitude of the peaks operated upon when the weighted sum of the individually phase shifted TR signals is added to the time domain data signal. As this again almost inevitably causes an increase in amplitude in other peaks further iterations of the method, operating on a progressively increasing number of peaks with an increased number of TR signals, each individually phase shifted to affect a different peak in the time domain data signal, are performed. Repeated performance of such iterations is computationally complex. In short, the TR technique reserves transmission tones to form a signal that, when a number of its sub-signals that have individually been phase shifted and then added in a weighted addition, reduces the PAPR of the signal to be transmitted.

The inventors have realised that the benefits derivable from later iterations of this method diminish. The inventors have further realised that some time-domain samples of the data signal are highly unlikely to ever become a peak, no matter what the TR-AS signal looks like and that, as a consequence, these parts of the data can be ignored/not included for the purpose of the iterations performed when determining the TR signal. Based on this the inventors have realised that TR-AS can successfully be employed in a manner that is computationally less complex by using as input for the TR-AS algorithm only those peaks of the signal to which PAPR reduction is to be applied that are higher than a predetermined threshold, thereby achieving a reduction in computational complexity.

Since the hybrid method consists of two separate schemes with their own overhead, the overhead of the hybrid method could be higher than that of the individual schemes. However TR-AS can use a large number of allocated tones. In DVB-T2, for example, there are 288 TR-AS tones in a 32768 subcarrier system. Since, in the embodiment, the PTS scheme uses a very small codebook to operate in the low complexity region, it is easy to use some of the TR-AS tones for signalling PTS information. For instance, if the codebook size if 4, only two bits need to be signalled and maybe only 3-4 tones are required if these bits are encoded for protection. This will not reduce the performance of the TR-AS method in any significant way.

In the conventional PTS algorithm, outlined in FIG. 1, the input data symbols Xₖ are split into V groups on non-overlapping subcarriers, S_{ν}, ν=1, . . . , V and all the IDFTs of the individual subgroups are computed,

$${x}_{n}^{( v )} = \frac{1}{\sqrt{NL}} {\sum }_{k ∈ {S}_{v}}^{ } {X}_{k}^{( v )} {e}^{j2 π nk / NL}$$

where N is the number of subcarriers and L is the oversampling factor. The partial IDFTs are then combined using each codeword c^{(d)} from the codebook, \tilde{x}ₙ^{(d)}=Σ_{μ=1}^{V}c_{ν}^{(d)}xₙ^{(ν)}, d=1, . . . , D. The codeword which produces the lowest PAPR,

$$\hat{d} = arg {min}_{d} {max}_{n} \vert {\tilde{x}}_{n}^{( d )} \vert ,$$

is then used.

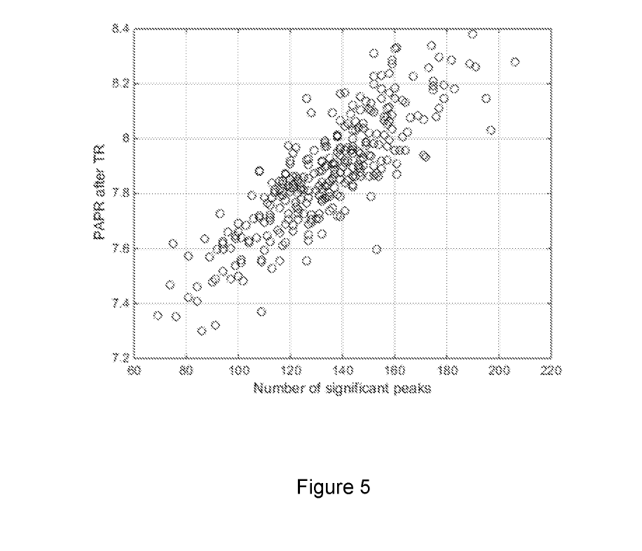

In the modified PTS algorithm of the embodiment, another selection criterion is used. Instead of determining the combined signal with the lowest PAPR, the combined signal which has the fewest peaks above a certain threshold is selected. The inventors have realised that, by choosing this input to the TR-AS method, the residual PAPR after TR-AS can be reduced. This is illustrated in FIG. 5, which shows the PAPR after the second step (TR-AS) as a function of the number of significant peaks of the input signal provided to the TR-AS part of the embodiment. The optimal codeword is consequently chosen in the embodiment as:

$$\hat{d} = arg {min}_{d} {\sum }_{n}^{ } I ( \vert {\tilde{x}}_{n}^{( d )} \vert > A )$$

where I(X) is the indicator function, i.e., it is 1 if the statement X is true and zero otherwise, and A is the threshold. The produced time-domain signal, \tilde{x}ₙ^{(\hat{d})}, is then passed on to the TR-AS algorithm. In order to reduce the PAPR as much as possible with a small codebook, the codebook is chosen as the DFT matrix,

$${c}_{v}^{( d )} = \frac{1}{\sqrt{V}} {e}^{- j 2 π vd / V} ,$$

with D=V to make all codewords orthogonal. Note that the embodiment is not limited in this fashion and that instead it is possible to use other orthogonal vectors.

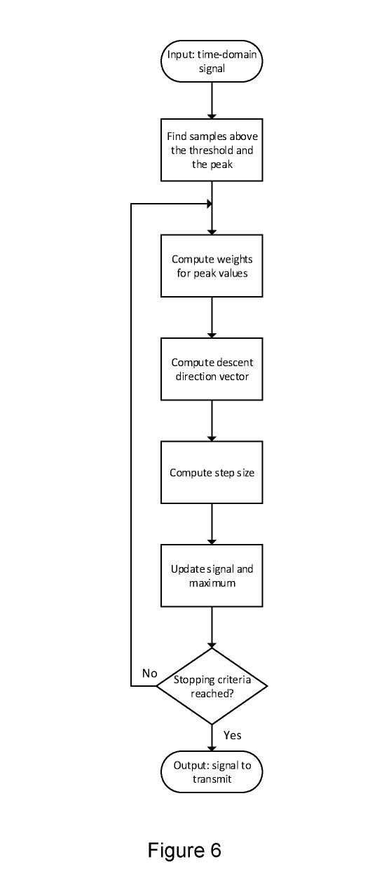

The TR-AS according to the embodiment, outlined in FIG. 6, works as follows. The TR-AS tones are used to form a kernel, pₙ. This can be done by setting the TR-AS values to one,

$${p}_{n} = \frac{1}{R} {\sum }_{k ∈ ℛ}^{ } {e}^{j 2 π nk / NL} ,$$

where [symbol] is the set of the R TR-AS tones. Note that p₀=1 and that other kernels may be used. To reduce complexity, only samples of the input signal above a certain threshold A are considered, i.e., [symbol] ={n:|xₙ|>A}. At the same time as these samples are found, the peak of the signal, \hat{n}₁=arg maxₙ|xₙ|, E⁽⁰⁾=|x_{\hat{n}}_{₁}|, is also computed and added to set of peaks, [symbol] ={\hat{n}₁}. The descent direction vector, pₙ⁽¹⁾=α₁⁽¹⁾p_{n-\hat{n}}_{₁}, is then computed by finding the weight α₁⁽¹⁾ which phase aligns the descent direction vector with the input signal at the peak, i.e., ∠p_{\hat{n}}_{₁}⁽¹⁾=∠x_{\hat{n}}_{₁}; hence α₁⁽¹⁾=e^{j∠x\hat{n}}^{₁}. Next the step size is found such that the reduced peak becomes as large as another peak. This is done by computing the required step size for each sample

μ(n)⇒|xₙ−μ(n)pₙ⁽¹⁾|=E⁽⁰⁾−μ(n), nε [symbol] \

[symbol]

and taking the smallest one, [symbol] μ(n).

It moreover needs to be ensured that the power limit of the TR-AS signal is not exceeded. The inventors have realised that, if each TR tone has a power limit, this might result in a low average power of the TR signal since not all TR tones will reach their limit. This was realised as being too restrictive. In the embodiment therefore a limit is imposed on the average power P of the TR tones in the embodiment. Denoting the time-domain TR-AS signal by cₙ⁽¹⁾ and its frequency-domain representation by Cₖ⁽¹⁾, we need to have

$$\frac{1}{R} {\sum }_{k ∈ ℛ}^{ } {\vert {C}_{k}^{( 1 )} \vert}^{2} \leq P$$

which means that

$${C}_{k}^{( 1 )} = μ {P}_{k}^{( 1 )} = {μα}_{1}^{( 1 )} {P}_{k} ⇒ μ \leq \sqrt{P \frac{NL}{R}} .$$

where Pₖ⁽¹⁾ and Pₖ are the frequency-domain versions of pₙ⁽¹⁾ and pₙ, respectively. The step size is then chosen as

$$μ = min \{ {min}_{n ∈ ℬ} μ ( n ) , \sqrt{P \frac{NL}{R}} \}$$

The new peak \hat{n}₂= [symbol] μ(n) is then added to the set of peak locations, [symbol] ={\hat{n}₁,\hat{n}₂} and the new maximum is updated, E⁽¹⁾=E⁽⁰⁾−μ.

In the ith iteration of the algorithm, the weights αⱼ⁽ⁱ⁾, j=1, . . . , i are found such that the descent direction vector, pₙ⁽ⁱ⁾=Σⱼ₌₁ⁱαⱼ⁽ⁱ⁾p_{n-\hat{n}}_{ⱼ}, is phase aligned with the data signal at the peak locations, ∠xₙ⁽ⁱ⁾=∠pₙ⁽ⁱ⁾,∀nε [symbol] . This can be done by solving an i×i linear system of equations

$$( \begin{matrix}{p}_{0} & {p}_{{\hat{n}}_{2} - {\hat{n}}_{1}} & … & {p}_{{\hat{n}}_{i} - {\hat{n}}_{1}} \\ {p}_{{\hat{n}}_{1} - {\hat{n}}_{2}} & {p}_{0} & … & {p}_{{\hat{n}}_{i} - {\hat{n}}_{2}} \\ ⋮ & ⋮ & ⋱ & ⋮ \\ {p}_{{\hat{n}}_{i} - {\hat{n}}_{1}} & {p}_{{\hat{n}}_{i} - {\hat{n}}_{2}} & … & {p}_{0}\end{matrix} ) ( \begin{matrix}{α}_{1}^{( i )} \\ {α}_{2}^{( i )} \\ ⋮ \\ {α}_{i}^{( i )}\end{matrix} ) = ( \begin{matrix}{e}^{j ∠ {x}_{{\hat{n}}_{1}}^{( i )}} \\ {e}^{j ∠ {x}_{{\hat{n}}_{2}}^{( i )}} \\ ⋮ \\ {e}^{j ∠ {x}_{i}^{( i )}}\end{matrix} ) .$$

A step size is then found which makes a new peak equal to the reduced ones

μ(n)⇒|xₙ⁽ⁱ⁾−μ(n)pₙ⁽ⁱ⁾|=E⁽ⁱ⁻¹⁾−μ(n), nε [symbol] \

[symbol]

The power constraint must also be fulfilled

$$\frac{1}{R} {\sum }_{k ∈ ℛ}^{ } {\vert {C}_{k}^{( i - 1 )} {μ}^{′} {P}_{k}^{( i )} \vert}^{2} \leq P$$

which can be ensured by solving the second order equation

$${μ}^{′} \leq \frac{\sqrt{{b}^{2} - a c} - b}{a}$$

$$a = {\sum }_{k ∈ ℛ}^{ } {\vert {P}_{k}^{( i )} \vert}^{2}$$

$$b = Re \{ {\sum }_{k ∈ ℛ}^{ } {C}_{k}^{( i - 1 )} {P}_{k}^{( i ) *} \}$$

$$c = {\sum }_{k ∈ ℛ}^{ } {\vert {C}_{k}^{( i - 1 )} \vert}^{2} - PR$$

The step size is then chosen to fulfil all constraints

$$μ = min \{ {μ}^{′} {, min}_{n ∈ ℬ} μ ( n ) \}$$

The TR-AS signal is then updated, cₙ⁽ⁱ⁾=cₙ⁽ⁱ⁻¹⁾+μpₙ⁽ⁱ⁾ and Cₖ⁽ⁱ⁾=Cₖ⁽ⁱ⁻¹)+μPₖ⁽ⁱ⁾, as well as the data signal, xₙ⁽ⁱ⁾=xₙ−cₙ⁽ⁱ⁾. The maximum is updated as E⁽ⁱ⁾=E⁽ⁱ⁻¹⁾−μ and the new peak \hat{n}ᵢ=arg [symbol] μ(n) is added to the set of peaks [symbol] ← [symbol] ∪\hat{n}ᵢ.

These iterations are then repeated until a stopping criterion is met, which could be the number of iterations, size of μ, etc.

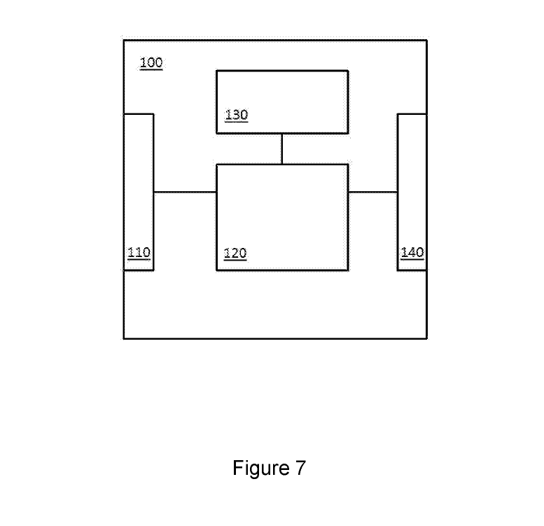

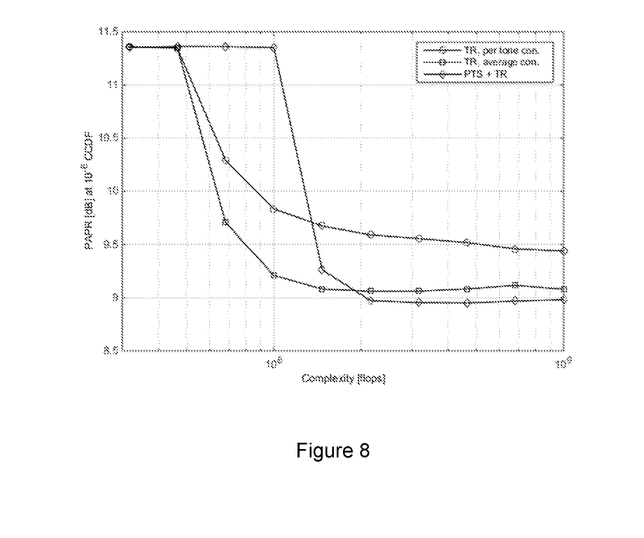

FIG. 7 shows a device 100 in which the hybrid PAPR reduction method of the embodiments can be implemented. The device comprises an input port 100 for receiving an unmodified OFDM signal, a processor 120, a memory 130 and an output port 140. The memory 130 is communicatively connected to the processor 120 and stores code for execution by the processor 120. When the processor 120 executes the code stored in memory 130 the steps of the embodiments are applied to OFDM signals received through the input port 110. Signals that have thus undergone PAPR reduction are transmitted to components located downstream of the device 100 through the output port 140. Such downstream components may be components that form part of the transmit chain of an OFDM transmitter, with the device 100 being a part of this transmitter. The transmitter may be any OFDM transmitter, such as a base station or a TV broadcaster.

### EXAMPLE

The conventional method can be considered to be TR-AS with a power limitation on each TR-AS tone (“TR-AS, per tone con.”). This is improved by the preferred embodiment by applying an average power constraint instead to the TR-AS tones (“TR-AS, average con.”). In the embodiment the PTS technique with the above described “number-of-peaks selection criterion” is combined with the TR-AS technique, wherein in TR-AS an average power constraint, instead of an absolute power constraint is applied.

The performance of the combined method of the embodiment (referred to herein as PTR+TR) was evaluated using simulation for a system with N=32768 subcarriers and an oversampling factor of L=8. The TR-AS schemes used as a comparison have R=256 subcarriers. The hybrid scheme uses 253 subcarriers for the TR-AS stage and allocates 3 subcarriers to convey the PTS information. To convey the PTS codebook information log₂ V=2 bits need to be transmitted. These can be encoded as:
00→000000
01→000111
10→111000
11→111111

These 6 bits can be modulated onto 3 QPSK symbols. The overhead for the embodiment is hence 256 subcarriers as well.

The performances of all schemes are shown in FIG. 7 as a function of complexity (number of floating point operations, “flops”). The ordinate axis is the level y for which there is a 10⁻⁶ probability that the instantaneous (normalised) power of the Transmitted signal exceeds

$$Pr ( \frac{{\vert x \vert}^{2}}{E \{ {\vert x \vert}^{2} \}} > γ ) = {10}^{- 6}$$

As can be seen, the proposed hybrid method achieves a lower PAPR than TR-AS on its own. For very low complexities, the performance of the schemes equal that of no PAPR reduction, since there are not enough flops available to reduce the PAPR. A significant reduction in PAPR is, however, achieved in the middle/high complexity region.

Most PAPR reduction techniques have diminishing returns, i.e., the performance improvements reduce in size when more complexity is allowed. By combining two different techniques, the regions where large improvements in PAPR can be achieved is increased at only a moderate cost in increased complexity. By tailoring the individual methods to work together, an efficient hybrid method is constructed which offers a good performance-complexity trade off.

Whilst certain embodiments have been described, these embodiments have been presented by way of example only, and are not intended to limit the scope of the inventions. Indeed, the novel devices, and methods described herein may be embodied in a variety of other forms; furthermore, various omissions, substitutions and changes in the form of the devices, methods and products described herein may be made without departing from the spirit of the inventions. The accompanying claims and their equivalents are intended to cover such forms or modifications as would fall within the scope and spirit of the inventions.

1. A method of reducing PAPR of an OFDM signal comprising:
a first PAPR reduction method in which an intermediate signal is generated so that the number of signal peaks above a first predetermined threshold is substantially minimised; and
a second PAPR reduction method in which the PAPR of the intermediate signal is reduced.

2. A method according to claim 1, wherein the first PAPR reduction method is a partial transmit sequence (PTS) method in which a codeword that reduces or substantially minimises the number of peaks above the first predetermined threshold is chosen.

3. A method according to claim 2, wherein the codeword is the DFT matrix.

4. A method according to any preceding claim, wherein the second PAPR reduction method is a tone reservation (TR) method.

5. A method according to claim 4, wherein in the second PAPR reduction method a tone reserved signal is optimised only with respect to signal peaks that have an amplitude above a second predetermined threshold.

6. A method according to claim 4 or 5, wherein in the TR method an average power of the TR signal is limited.

7. A method of reducing PAPR of an OFDM signal comprising initially reducing PAPR using PTS in a low or medium complexity, medium or high PAPR reduction region and, thereafter, reducing PAPR further using TR in a low or medium complexity medium or high PAPR reduction region.

8. A method of reducing PAPR of an OFDM signal using tone reservation by optimising a tone reservation signal based only on peaks of the OFDM signal that are above a predetermined threshold.

9. A device comprising an input for receiving an OFDM signal, a processor and a memory for storing code, the code configured to, when executed by the processor, cause the processor to generate a modified signal with reduced PAPR based on the OFDM signal by performing:
a first PAPR reduction method in which an intermediate signal is generated so that the number of signal peaks above a predetermined threshold is substantially minimised; and
a second PAPR reduction method in which the PAPR of the intermediate signal is reduced.

10. A device according to claim 9, wherein the first PAPR reduction method is a partial transmit sequence (PTS) method in which a codeword that reduces or substantially minimises the peaks above the first predetermined threshold is chosen.

11. A device according to claim 10, wherein the codeword is the DFT matrix.

12. A device according to any of claims 9 to 11, wherein the second PAPR reduction method is a tone reservation (TR) method.

13. A device according to claim 12, wherein in the TR method a tone reserved signal is optimised only with respect to signal peaks that have an amplitude above a predetermined threshold.

14. A device according to claim 12 or 13, wherein in the TR method an average power of the TR signal is limited.

15. A device comprising an input for receiving an OFDM signal, a processor and a memory for storing code, the code configured to, when executed by the processor, cause the processor to generate a modified signal with reduced PAPR based on the OFDM signal by initially reducing PAPR using PTS in a low or medium complexity, medium or high PAPR reduction region and, thereafter, reducing PAPR further using TR in a low or medium complexity medium or high PAPR reduction region.

16. A device comprising an input for receiving an OFDM signal, a processor and a memory for storing code, the code configured to, when executed by the processor, cause the processor to generate a modified signal with reduced PAPR based on the OFDM signal by performing:
selecting peaks of the OFDM signal that are above a predetermined threshold; and
reducing PAPR of an OFDM signal only on the selected peaks.

17. An OFDM transmitter comprising a device according to any of claims 9 to 16 and a transmitting unit configured to receive a PAPR reduced OFDM signal and transmit it into a wireless transmission channel.

18. An OFDM transmitter according to claim 17, wherein the OFDM transmitter is a base station or a TV broadcaster.
